(19) United States
(12) Patent Application Publication
(10) Pub. No.: US 2019/0170087 A1
(43) Pub. Date: Jun. 6, 2019

(54) THRUST VECTOR CONTROLLER

(71) Applicant: Yao-Chang Lin, Hsinchu City (TW)

(72) Inventor: Yao-Chang Lin, Hsinchu City (TW)

(21) Appl. No.: 15/859,091

(22) Filed: Dec. 29, 2017

(30) Foreign Application Priority Data
Dec. 6, 2017 (TW) 106142824

(51) Int. Cl. F02K 1/00

(52) U.S. Cl. CPC F02K 1/004

(57) ABSTRACT

A thrust vector controller includes an airflow guiding member, a connecting member, a first driving device, and a second driving device. The airflow guiding member is adjacent to an air exhaust opening. The airflow guiding member includes a main body, a first driving portion, a second driving portion, and a connecting portion. Airflow passes through the main body and is guided by the main body. The first driving portion, the second driving portion, and the connecting portion are connected to the main body. The connecting member is movably connected to the connecting portion and an exhaust propulsion device. The main body is movably connected to the exhaust propulsion device through the connecting portion and the connecting member. The first driving device is connected to the first driving portion and drives the first driving portion to move the airflow guiding member toward a first direction.

### FIELD OF THE INVENTION

The present invention relates to an airflow direction guiding device, and more particularly to a thrust vector controller.

### BACKGROUND OF THE INVENTION

Flying into the sky is not only a human dream but also a very efficient mode of transportation. It possesses the efficiency of quickly arriving at the destination. Therefore, it can remove the gap between people caused by space. Consequently, flying is not only with entertainment and business nature, but also with a further great demand for other applications.

For a fixed-wing aircraft, it is true that it can carry a large number of personnel and goods, but such a vehicle needs a long runway and a lot of related takeoff and landing equipment, thus only confined to the airport takeoff and landing. To overcome this restriction, a rotorcraft, such as a helicopter, which is capable of vertical takeoff and landing, is additionally developed. But even if for a rotorcraft capable of vertical takeoff and landing, a considerable area of apron still needs to be set up and it is unable to pickup and drop off passengers like a ground vehicle. Moreover, it is still difficult for a helicopter to enter a narrow passageway and an ordinary roof in the metropolis with high-density buildings.

Therefore, there have currently been research and development teams starting to research and develop single vertical lift aircrafts available to be used in the metropolis with high-density buildings and narrow space. Due to its small size, a single aircraft does not have a larger wing like a fixed-wing aircraft and thus does not have a lift wing and an empennage of a fixed-wing aircraft for controlling the ascent, descent, and direction. Therefore, it becomes an important issue for a single aircraft how to control the direction of a single aircraft.

### SUMMARY OF THE INVENTION

The present invention provides a thrust vector controller. For an aircraft using an exhaust propulsion device, the thrust vector controller of the present invention may be disposed at an air exhaust opening of the exhaust propulsion device. When the exhaust propulsion device discharges airflow through the air exhaust opening to generate thrust, the thrust vector controller of the present invention can guide the airflow to change an airflow direction and to further change a direction of the thrust to allow the aircraft to change directions, ascend, or descend.

Other objects and advantages of the present invention may be further illustrated by the technical features broadly embodied and described as follows.

In order to achieve one or a portion of or all of the objects or other objects, an embodiment of the thrust vector controller provided by the present invention may be used for the exhaust propulsion device of the aircraft. The exhaust propulsion device has an air exhaust opening and may generate an airflow that is discharged from the air exhaust opening to generate the thrust. An embodiment of the thrust vector controller of the present invention includes an airflow guiding member, a connecting member, a first driving device, and a second driving device. The airflow guiding member is adjacent to the air exhaust opening and surrounds the air exhaust opening. The airflow passes through the airflow guiding member and is guided by the airflow guiding member. The connecting member is movably connected to the airflow guiding member and the exhaust propulsion device. The first driving device drives the airflow guiding member to move toward a first direction relative to the exhaust propulsion device. The first direction is from a peripheral surface of the airflow guiding member through a center of the airflow guiding member. The second driving device drives the airflow guiding member to move toward a second direction relative to the exhaust propulsion device. The second direction is from the peripheral surface of the airflow guiding member through the center of the airflow guiding member. The first direction is not parallel to the second direction.

In an embodiment of the present invention, the airflow guiding member includes a main body, a first driving portion, a second driving portion, and a connecting portion. The airflow passes through the main body and is guided by the main body. The connecting member is rotatably connected to the connecting portion. The main body is rotatably connected to the exhaust propulsion device through the connecting portion and the connecting member. The first driving portion, the second driving portion, and the connecting portion are connected to the main body. The first driving device is connected to the first driving portion and drives the first driving portion to further drive the airflow guiding member to move toward the first direction. The second driving device is connected to the second driving portion and drives the second driving portion to further drive the airflow guiding member to move toward the second direction.

In an embodiment of the present invention, the main body includes a first diversion portion and a support portion. The first diversion portion surrounds the air exhaust opening and guides the airflow to be discharged toward one direction. The support portion supports at an inner wall of the first diversion portion to maintain the state in which the first diversion portion surrounds the air exhaust opening.

In an embodiment of the present invention, the support portion includes a first support member and a second support member. The two opposite ends of the first support member are connected to an inner wall surface of the first diversion portion. The two opposite ends of the second support member are connected to the inner wall surface of the first diversion portion. The first support member and the second support member are cross-connected to each other.

In an embodiment of the present invention, the main body further includes a second diversion portion. The second diversion portion is concentrically disposed with the first diversion portion and connects the support portion.

In an embodiment of the present invention, both the first diversion portion and the second diversion portion are tubular.

In an embodiment of the present invention, the connecting portion is disposed at the place where the first support member and the second support member are cross-connected.

In an embodiment of the present invention, the place where the first support member and the second support member are cross-connected is located at a geometric center of the first diversion portion.

In an embodiment of the present invention, the first driving portion and the second driving portion are disposed at the first diversion portion. The first driving portion and the second driving portion are a central angle of 90 degrees away from each other relative to the geometric center of the first diversion portion.

In an embodiment of the present invention, the first support member and the second support member are disposed by perpendicularly crossing each other. The first driving portion is disposed at the place where the first support member is connected to the first diversion portion. The second driving portion is disposed at the place where the second support member is connected to the first diversion portion.

In an embodiment of the present invention, the connecting member includes a universal joint.

In an embodiment of the present invention, the first driving device and the second driving device are disposed at the exhaust propulsion device.

In an embodiment of the present invention, the first direction is perpendicular to the second direction.

The thrust vector controller of the present invention is disposed at the air exhaust opening of the exhaust propulsion device and can guide the airflow to be discharged from the exhaust propulsion device to the desired direction, so that the thrust of the exhaust propulsion device can act not only along an axis center but also in other directions. Thus, an effect of changing directions, ascent, and descent can be generated for the aircraft equipped with the exhaust propulsion device.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of an embodiment of a thrust vector controller of the present invention, disposed at an exhaust propulsion device;

FIG. 2 is a schematic perspective view of an embodiment of the thrust vector controller of the present invention; and

FIG. 3 is a schematic top view for FIG. 2.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

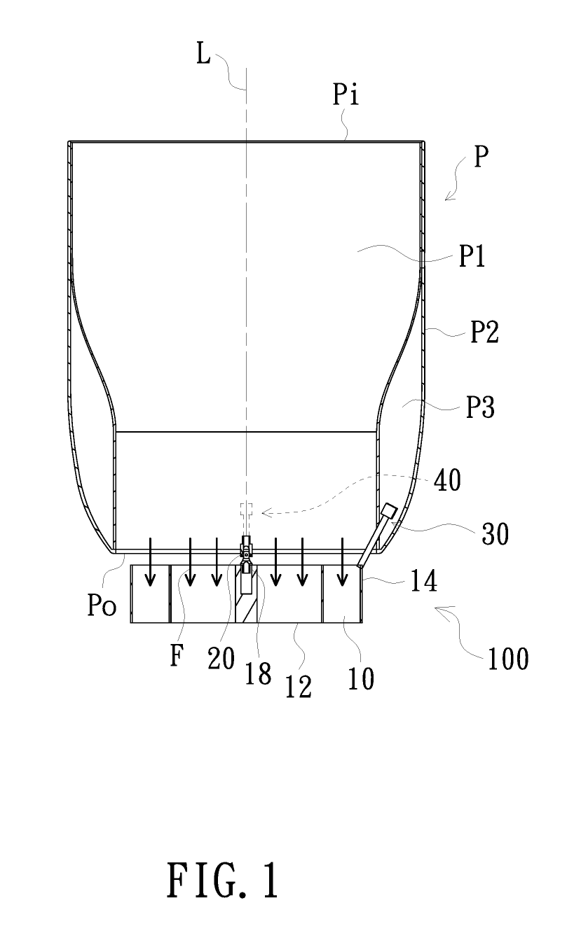

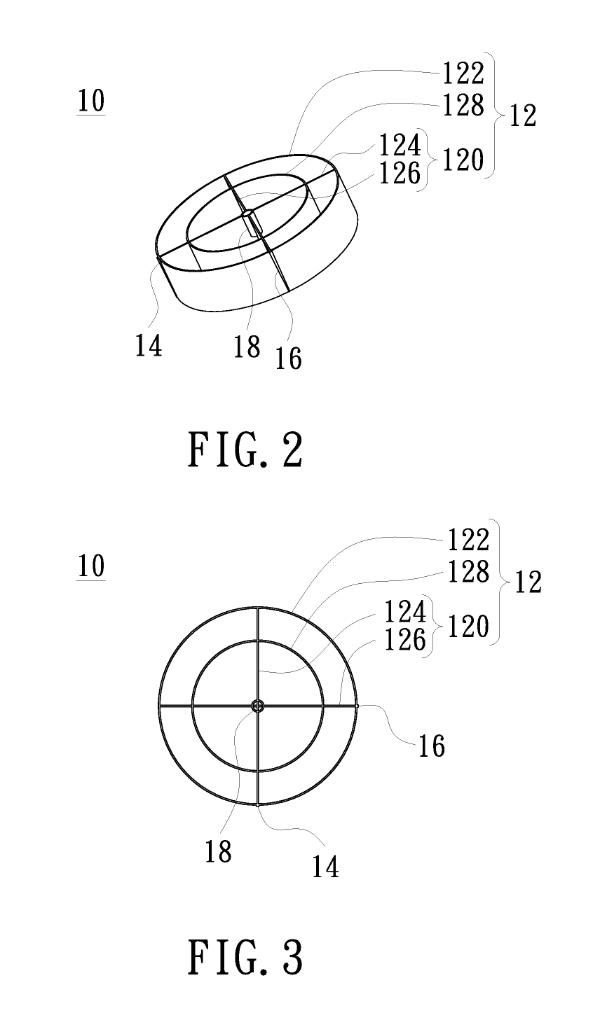

Please refer to FIG. 1, FIG. 2 and FIG. 3. FIG. 1 shows an embodiment of a thrust vector controller of the present invention, installed to an exhaust propulsion device. FIG. 2 and FIG. 3 show an embodiment of the thrust vector controller of the present invention. The thrust vector controller 100 of the present invention may be used for an exhaust propulsion device P of an aircraft. The exhaust propulsion device P has an air intake opening Pi and an air exhaust opening Po. An airflow passageway P1 is formed between the air intake opening Pi and the air exhaust opening Po. Air enters the exhaust propulsion device P from the air intake opening Pi. The exhaust propulsion device P may generate an airflow F in the airflow passageway P1 with, for example, a propeller, and discharge the airflow F from the air exhaust opening Po. The thrust vector controller 100 includes an airflow guiding member 10, a connecting member 20, a first driving device 30, and a second driving device 40. The airflow guiding member 10 is disposed adjacent to the air exhaust opening Po. The airflow guiding member 10 is movably connected to the exhaust propulsion device P through the connecting member 20 and is aligned with the air exhaust opening Po. The airflow discharged from the air exhaust opening Po passes through the airflow guiding member 10. In the present embodiment, the connecting member 20 may be, for example, fixed to the air exhaust opening Po of the exhaust propulsion device P at one end and rotatably connected to the airflow guiding member 10 at the other end thereof, so that the airflow guiding member 10 can be swung in any direction of 360 degrees on a plane parallel to the air exhaust opening Po relative to the air exhaust opening Po. The first driving device 30 and the second driving device 40 may push the airflow guiding member 10 to move in a first direction and a second direction, respectively. The first direction and the second direction may be two non-parallel directions among any of the above-mentioned 360-degree directions. The first direction is a direction from a peripheral surface of the airflow guiding member 10 through a center of the airflow guiding member 10. The second direction is also a direction from the peripheral surface of the airflow guiding member 10 through the center of the airflow guiding member 10. But the first direction is not parallel to the second direction. Meanwhile, by varying the amount of displacement of the airflow guiding member 10 in the first direction and the second direction, the airflow guiding member 10 is configured to be tiltable relative to an axis center L of the exhaust propulsion device P in each direction within a 360-degree range around its periphery. A different tilt angle may be formed relative to the axis center L of the exhaust propulsion device P in any direction so that the airflow F is guided to the desired direction.

The first driving device 30 and the second driving device 40 are disposed at the exhaust propulsion device P. In the present embodiment, the first driving device 30 and the second driving device 40 are disposed in a space P3 formed between a shell P2 of the exhaust propulsion device P and the airflow passageway P1. In the present embodiment, the first driving device 30 includes a stepping motor and a control line. The control line is connected with an output shaft of the stepping motor and the airflow guiding member 10. The output shaft of the stepping motor is controlled to rotate to pull the control line so that the airflow guiding member 10 is swung in one direction. The second driving device 40 also has a stepping motor and a control line. The output shaft of the stepping motor is controlled to rotate to pull the control line so that the airflow guiding member 10 is swung in another direction. In this way, the airflow guiding member 10 can be controlled to tilt relative to the axis center L of the exhaust propulsion device P in each direction within a 360-degree range around its periphery so that the airflow F is guided to the desired direction.

As shown in FIG. 2 and FIG. 3, the airflow guiding member 10 includes a main body 12, a first driving portion 14, a second driving portion 16, and a connecting portion 18. The airflow F passes through the main body 12 and is guided by the main body 12. The first driving portion 14, the second driving portion 16, and the connecting portion 18 are connected to the main body 12. The connecting member 20 is movably connected to the connecting portion 18 and the exhaust propulsion device P (please refer to FIG. 1). The main body 12 is movably connected to the exhaust propulsion device through the connecting portion 18 and the connecting member 20. In the present embodiment, the connecting member 20 may be a universal joint. Thus, the main body 12 and the connecting portion 18 can be swung toward any direction within a 360-degree range in which the connecting member 20 is a center, and be tilted with respect to the axis center L of the exhaust propulsion device P. The first driving device 30 is connected to the first driving portion 14 and drives the first driving portion 14 to move the airflow guiding member 10 toward the first direction. The second driving device 40 is connected to the second driving portion 16 and drives the second driving portion 16 to move the airflow guiding member 10 toward the second direction. In the present embodiment, the first direction is not parallel to the second direction. In this way, the airflow guiding member 10 can be swung toward any direction within a 360-degree range in which the connecting member 20 is a center, and be tilted with respect to the axis center L of the exhaust propulsion device P. The tilt angle between the airflow guiding member 10 and the axis center L of the exhaust propulsion device P can be adjusted by changing the amount of displacement of the airflow guiding member 10 in the first direction and the second direction. Preferably, the first direction is perpendicular to the second direction, so that they can be adapted to a control means based on a rectangular coordinate.

In the present embodiment, the main body 12 includes a first diversion portion 122 and a first support portion 120. The first diversion portion 122 surrounds the air exhaust opening Po. The airflow F is guided by the first diversion portion 122 to be discharged in one direction. The first support portion 120 supports at an inner wall of the first diversion portion 122 to maintain the shape of the first diversion portion 122 and thereby to maintain the state in which the first diversion portion 122 surrounds the air exhaust opening Po. The first support portion 120 includes a first support member 124 and a second support member 126. The two opposite ends of the first support member 124 are connected to an inner wall surface of the first diversion portion 122. The two opposite ends of the second support member 126 are connected to the inner wall surface of the first diversion portion 122. The first support member 124 and the second support member 126 are cross-connected to each other. In the present embodiment, the first support member 124 and the second support member 126 are elongated members. The inner wall surface of the first diversion portion 122 is supported by the first support member 124 and the second support member 126 by connecting the two opposite ends of the first support member 124 to the inner wall surface of the first diversion portion 122 and connecting the two opposite ends of the second support member 126 to the inner wall surface of the first diversion portion 122. The shape of the first diversion portion 122 may be maintained so that the state in which the first diversion portion 122 surrounds the air exhaust opening Po is maintained. Preferably, the place where the first support member 124 and the second support member 126 are cross-connected is located at a geometric center of the first diversion portion 122. The first diversion portion 122 is aligned with the air exhaust opening Po of the exhaust propulsion device P. Preferably, the axis center L of the exhaust propulsion device P passes through the geometric center of the first diversion portion 122 when the airflow guiding member 10 is not displaced. In the present embodiment, the main body 12 further includes a second diversion portion 128. The second diversion portion 128 is concentrically disposed with the first diversion portion 122 and connected to the first support member 124 and the second support member 126. The airflow F discharged from the air exhaust opening Po of the exhaust propulsion device P passes through the first diversion portion 122 and the second diversion portion 128. Therefore, by configuring the first diversion portion 122 and the second diversion portion 128 to generate an amount of displacement in the first direction and the second direction, the first diversion portion 122 and the second diversion portion 128 may be controlled to be tilted relative to the axis center L of the exhaust propulsion device P in each direction within a 360-degree range around the periphery thereof, so that the airflow F is guided to the desired direction. In the present embodiment, the first diversion portion 122 and the second diversion portion 128 are tubular. Preferably, the first diversion portion 122 and the second diversion portion 128 are in the shape of a circular tube, so that the geometric center of the first diversion portion 122 is its center.

In the present embodiment, the first driving portion 14 and the second driving portion 16 are disposed at the first diversion portion 122. The first driving portion 14 and the second driving portion 16 are a central angle of 90 degrees away from each other relative to the geometric center of the first diversion portion 122. As shown in FIG. 3, the first driving portion 14 and the second driving portion 16 are disposed at an outer peripheral wall of the first diversion portion 122. In the present embodiment, the first driving portion 14 and the second driving portion 16 are ribs, extended in the axial direction of the first diversion portion 122 and disposed at the outer peripheral wall of the first diversion portion 122. In the present embodiment, the first driving portion 14 is disposed at the place where the first support member 124 and the first diversion portion 122 are connected. The second driving portion 16 is disposed at the place where the second support member 126 and the first diversion portion 122 are connected.

The thrust vector controller 100 of the present invention is disposed at the air exhaust opening Po of the exhaust propulsion device P. The airflow F discharged from the exhaust propulsion device P can be guided to the desired direction so that the thrust of the exhaust propulsion device P can act not only along the axis center L, but also in other directions. Thus, an effect of changing directions, ascent and descent can be generated for the aircraft equipped with the exhaust propulsion device P.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A thrust vector controller, for an exhaust propulsion device having an air exhaust opening and generating airflow to be discharged from the air exhaust opening, the thrust vector controller comprising:
an airflow guiding member, adjacent to the air exhaust opening and surrounding the air exhaust opening, wherein the airflow passes through the airflow guiding member and is guided by the airflow guiding member;
a connecting member, movably connected to the airflow guiding member and the exhaust propulsion device;
a first driving device, configured to drive the airflow guiding member to move toward a first direction relative to the exhaust propulsion device, wherein the first direction is from a peripheral surface of the airflow guiding member through a center of the airflow guiding member; and
a second driving device, configured to drive the airflow guiding member to move toward a second direction relative to the exhaust propulsion device, wherein the second direction is from the peripheral surface of the airflow guiding member through the center of the airflow guiding member and the first direction is not parallel to the second direction.

2. The thrust vector controller according to claim 1, wherein the airflow guiding member comprises a main body, a first driving portion, a second driving portion and a connecting portion, the airflow passes through the main body and is guided by the main body, the connecting member is rotatably connected to the connecting portion, the main body is rotatably connected to the exhaust propulsion device through the connecting portion and the connecting member, the first driving portion, the second driving portion and the connecting portion are connected to the main body, the first driving device is connected to the first driving portion and drives the first driving portion to further drive the airflow guiding member to move toward the first direction, and the second driving device is connected to the second driving portion and drives the second driving portion to further drive the airflow guiding member to move toward the second direction.

3. The thrust vector controller according to claim 2, wherein the main body comprises a first diversion portion and a support portion, the first diversion portion surrounds the air exhaust opening, the airflow is guided by the first diversion portion and discharged toward one direction, and the support portion supports at an inner wall of the first diversion portion to maintain a state in which the first diversion portion surrounds the air exhaust opening.

4. The thrust vector controller according to claim 3, wherein the support portion comprises a first support member and a second support member, two opposite ends of the first support member are connected to an inner wall surface of the first diversion portion, two opposite ends of the second support member are connected to the inner wall surface of the first diversion portion, and the first support member and the second support member are cross-connected to each other.

5. The thrust vector controller according to claim 3, wherein the main body further comprises a second diversion portion and the second diversion portion is concentrically disposed with the first diversion portion and connected to the support portion.

6. The thrust vector controller according to claim 5, wherein both the first diversion portion and the second diversion portion are tubular.

7. The thrust vector controller according to claim 3, wherein the connecting portion is disposed at a place where the first support member and the second support member are cross-connected.

8. The thrust vector controller according to claim 3, wherein a place where the first support member and the second support member are cross-connected is located at a geometric center of the first diversion portion.

9. The thrust vector controller according to claim 3, wherein the first driving portion and the second driving portion are disposed at the first diversion portion, and the first driving portion and the second driving portion are a central angle of 90 degrees away from each other relative to a geometric center of the first diversion portion.

10. The thrust vector controller according to claim 9, wherein the first support member and the second support member are disposed by perpendicularly crossing each other, the first driving portion is disposed at a place where the first support member and the first diversion portion are connected, and the second driving portion is disposed at a place where the second support member and the first diversion portion are connected.

11. The thrust vector controller according to claim 1, wherein the connecting member comprises a universal joint.

12. The thrust vector controller according to claim 1, wherein the first driving device and the second driving device are disposed at the exhaust propulsion device.

13. The thrust vector controller according to claim 1, wherein the first direction is perpendicular to the second direction.
